(19) United States
(12) Patent Application Publication
(10) Pub. No.: US 2008/0272705 A1
(43) Pub. Date: Nov. 6, 2008

(54) LIGHT EMITTING DIODE LAMP ASSEMBLY HAVING A VOLTAGE-REGULATING CAPABILITY

(76) Inventor: Chen-Sheng YANG, Kaohsiung (TW)

Correspondence Address: APEX JURIS, PLLC, 12360 LAKE CITY WAY NORTHEAST, SUITE 410, SEATTLE, WA, 98125, US

(21) Appl. No.: 11/742,759

(22) Filed: May 1, 2007

(51) Int. Cl. H05B 41/36

(52) U.S. Cl. 315/194

(57) ABSTRACT

The light emitting diode (LED) lamp assembly has an LED light string, a power plug, an AC to DC converter and a voltage-regulating element. The LED light string has multiple LEDs connected in series. The power plug is connected to the LED light string and obtains an AC power from an external AC power source. The AC to DC converter is retained and mounted in the power plug and is connected to the LED light string, wherein the AC to DC converter obtains and converts the AC power into a DC power. The voltage-regulating element is connected between the LED light string and the AC to DC converter in the power plug and has a constant voltage. Therefore, a voltage supplied to the LED light string is obtained by subtracting the constant voltage of the voltage-regulating element from the voltage of the DC power.

### BACKGROUND OF THE INVENTION

1. Field of the Invention

The present invention relates to a light emitting diode (LED) lamp assembly, and more particularly to an LED lamp assembly that has a voltage-regulating capability.

2. Description of Related Art

A light emitting diode (LED) lamp assembly comprises an LED light string having multiple LEDs, an adapter and a current-limiting resistor. The LEDs are connected together in series. The adapter is connected to the LED light string and an external AC power source to supply an operating power to the LED light string. The current-limiting resistor is further connected between the adapter and the LED light string to decrease the current flowing through the LEDs. However, to limit the current through the LED string effectively, the current-limiting resistor having a large resistance is required.

Since the large resistance of the current-limiting resistor is used, the temperature of the current-limiting resistor is easily increased when the LED light string operates for a while. Additionally, the current-limiting resistor will be dead when the temperature of the current-limiting resistor increases to be 70 degrees centigrade. Therefore, the LED lamp assembly has a heat problem. In addition, using the resistor having a large resistance also causes another big size problem.

To overcome the shortcomings, the present invention provides an LED lamp assembly that has a voltage-limiting capability to mitigate or obviate the aforementioned problems.

### SUMMARY OF THE INVENTION

The main objective of the invention is to provide a light emitting diode (LED) lamp assembly that has a voltage-regulating capability.

The LED lamp assembly in accordance with the present invention comprises an LED light string, a power plug, an AC to DC converter and a voltage-regulating element. The LED light string has multiple LEDs connected in series. The power plug is connected to the LED light string and obtains an AC power from an external AC power source. The AC to DC converter is retained and mounted in the power plug and is connected to the LED light string, wherein the AC to DC converter obtains and converts the AC power into a DC power. The voltage-regulating element is connected between the LED light string and the AC to DC converter in the power plug to and has a constant voltage. Therefore, a voltage supplied to the LED light string is obtained by subtracting the constant voltage of the voltage-regulating element from the voltage of the DC power.

Other objectives, advantages and novel features of the invention will become more apparent from the following detailed description when taken in conjunction with the accompanying drawings.

### BRIEF DESCRIPTION OF THE DRAWINGS

FIG. 1 is a schematic of a first embodiment of a light emitting diode lamp assembly in accordance with the present invention.

### DETAILED DESCRIPTION OF PREFERRED EMBODIMENT

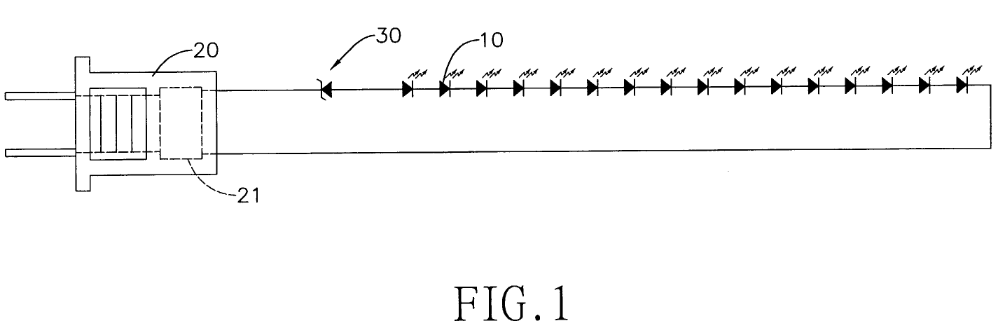

With reference to FIG. 1, Alight emitting diode (LED) lamp assembly in accordance with the present invention comprises a LED light string, a power plug (20), a AC to DC converter (21) and a voltage-regulating element.

The LED light string has multiple LEDs (10) that are connected together in series.

The power plug (20) is connected to the LED light string and obtains an AC power from an external AC power source.

The AC to DC converter (21) is retained and mounted in the power plug (20) and is connected to the LED light string. The AC to DC converter (21) converts the AC power into a DC power, wherein the DC power is supplied to the LED light string.

The voltage-regulating element is connected between the LED light string and the AC to DC converter (21) in the power plug (20) and has a constant voltage. Accordingly, a voltage supplied to the LED light string is obtained by subtracting the constant voltage of the voltage-regulating element from the voltage of the DC power. Furthermore, the voltage supplied to the LED light string is lower than that of the DC power output from the AC to DC converter (21). Therefore, a current flowing through the LEDs (10) is decreased.

For example, the voltage-regulating element is a zenor diode (30). The zenor diode (30) has a positive terminal and a negative terminal. The positive terminal of the zenor diode (30) is connected to the LED light string. The negative terminal of the zenor diode (30) is connected to the AC to DC converter (21) in the power plug (20). Accordingly, the zenor diode (30) will be reversely biased when it obtains the DC power output from the AC to DC converter (21). Based on the characteristic of the zenor diode (30), the zenor diode (30) will have a constant breakdown voltage when the zenor diode (30) operates in the reverse bias region. Therefore, the constant breakdown voltage of the zenor diode (30) reduces the voltage supplied to the LED light string, and further, the current flowing through the LEDs (10) is decreased.

With such an LED lamp assembly, the size of the zenor diode (30) is smaller than that of a current-limiting resistor with large resistance in a conventional LED lamp assembly. Furthermore, the zenor diode can still work normally when the temperature of the zenor diode is 105 degrees centigrade. Accordingly, the heat problem of the described LED lamp assembly is improved effectively and the size of the LED lamp assembly with a voltage regulating capability is able to further miniature. Therefore, using the described LED lamp assembly is more convenient than the conventional LED lamp assembly.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A light emitting diode (LED) lamp assembly having a voltage-regulating capability comprising:
a LED light string has multiple LEDs connected in series;
a power plug connected to the LED light string and adapted to connect to an AC power source to obtain an AC power;
an AC to DC converter retained and mounted in the power plug and connected to the LED light string, wherein the AC to DC converter obtains and converts the AC power into a DC power; and
a voltage-regulating element connected between the LED light string and the AC to DC converter in the power plug to and having a constant voltage, whereby a voltage supplied to the LED light string is obtained by subtracting the constant voltage of the voltage-regulating element from the voltage of the DC power.

2. The LED lamp assembly as claimed in claim 1, wherein the voltage-regulating element is a zenor diode having
a positive terminal connected to the LED light string; and
a negative terminal connected to the AC to DC converter in the power plug.
